(19) United States
(12) Patent Application Publication
(10) Pub. No.: US 2010/0125695 A1
(43) Pub. Date: May 20, 2010

(54) NON-VOLATILE MEMORY STORAGE SYSTEM

(75) Inventors: GARY WU, Fremont, CA (US); Roger Chin, San Jose, CA (US)

Correspondence Address: Tung & Associates, Suite 120, 838 W. Long Lake Road, Bloomfield Hills, MI, 48302, US

(73) Assignee: Nanostar Corporation

(21) Appl. No.: 12/271,885

(22) Filed: Nov. 15, 2008

(51) Int. Cl. G06F 12/00; G06F 12/02; G06F 12/06

(52) U.S. Cl. 711/103; 710/22; 711/114; 711/105; 711/E12.001; 711/E12.008; 711/E12.083

(57) ABSTRACT

The present invention discloses a flash memory storage system, comprising at least one RAID controller; a plurality of flash memory cards electrically connected with the RAID controller; and a cache memory electrically connected with the RAID controller and shared by the RAID controller and the flash memory cards. The cache memory efficiently enhances the system performance. The storage system may comprise more RAID controllers to construct a nested RAID architecture.

### BACKGROUND OF THE INVENTION

1. Field of the Invention

The present invention relates to a non-volatile memory storage system with a shared cache memory, and in particular to a non-volatile flash data storage system with a shared DRAM cache. The flash data storage system preferably includes non-volatile flash memory devices in RAID architecture.

2. Description of Related Art

A non-volatile memory storage system (or flash memory storage system) is a system including one or more non-volatile memory units. An example of such flash memory system is the non-volatile memory card. Non-volatile memory cards are memory cards made by non-volatile memory devices such as, but not limited to, Flash EEPROM, Nitride based non-volatile memory, etc. Such non-volatile or flash memory cards include, but are not limited to, USE flash drive, card bus card, SD flash card, MMC flash card, memory stick, MI card, Expresscard flash card, solid state drive (SSD), etc.

Flash memory controller should control the data transfer between a host and a flash memory. A conventional flash memory controller includes a Central Processor Unit (CPU), a host interface, an SRAM cache, and a flash interface. The conventional flash memory controller may read or write data to and from flash memories. These read and write operations of the flash memory controller may be carried out under control of the CPU. The flash memory controller responds to commands from a host. That is, the CPU receives commands from the host and then determines whether data from the host should be stored in a flash memory or data in the flash memory should be read out. The conventional flash memory controller implements wear-leveling, bad block management and ECC/EDC functions.

Flash data memory storage system is rugged, highly reliable and with higher speed as compared to those mechanically driven magnetic storage devices.

Norman Ken Ouchi at IBM obtained U.S. Pat. No. 4,092,732 titled “System for recovering data stored in failed memory unit” in 1978. The claims of this patent describe what later was termed RAID-5 with full stripe writes. This patent also mentions that disk mirroring (later termed RAID-1) and protection with dedicated parity (later termed RAID-4) were prior art at that time.

A hardware based RAID system employs dedicated electronic circuitry to perform the processing functions of the RAID system. RAID is used as an architecture for the mechanically driven magnetic storage devices to minimize the risk of data loss.

While the individual drives in a RAID system are still subject to the same failure rates, RAID significantly improves the overall reliability by providing one or more redundant arrays; in this way, data is available even if one of the drives fails.

A RAID Advisory Board has been established whereby standard RAID configurations are being defined as industry standards. For example, RAID-0 has disks with data stripped across the drives. Stripping is a known method of quickly storing blocks of data across a number of different drives. With RAID-0 each drive is read independently and there is no redundancy. This RAID-0 architecture has no fault tolerance feature. Any disk failure destroys the array. Accordingly, the RAID-0 configuration improves speed performance but does not increase data reliability, as compared to individual drives. RAID-1 is striped disk mirrored set without parity. RAID-1 provides fault tolerance from disk errors and failure of all but one of the drives. With this configuration many drives are required and therefore it is not an economical solution to data reliability. RAID-2 utilizes complex ECC (error correction codes) codes written on multiple redundant disks. RAID-3 incorporates redundancy using a dedicated disk drive to support the extra memory needed for parity, which is shared among all of the drives. This configuration is commonly used where high transfer rates are required and/or long blocks of data are used. RAID-4 is similar to RAID-3 in that it also uses interleaved parity; however unlike RAID-3, RAID-4 uses block-interleaved parity and not bit-interleaved parity. Accordingly, RAID-4 defines a parallel array using block striping and a single redundant parity disk. RAID-5 is striped disk or flash memory set with distributed parity. The memory array is not destroyed by a single drive failure. Upon drive failure, any subsequent reads can be calculated from the distributed parity such that the drive failure is masked from the end user. The array will have data loss in the event of a second drive failure.

The RAID-6 configuration includes striped set with dual distributed parity. RAID-6 provides fault tolerance from two drive failures; array continues to operate with up to two failed drives.

A RAID 50 combines the straight block-level striping of RAID-0 with the distributed parity of RAID-5. RAID-50 is one kind of the nested RAID architectures. The RAID-0 is primary RAID and the RAID-5 is secondary in the RAID-50 architecture.

Referring to FIG. 1A, a conventional circuit structure of a RAID controller 11 controlling multiple hard disk drives 100-10N is shown, the RAID controller 11 communicates with external circuits and the hard disk drives through, for example, IDE or SATA-II interface. The RAID engine usually work with a local cache (not shown), for example, a local SRAM to speed up the data rebuilding process. In case one of the hard drives fails, the RAID controller will enter into degraded mode. If the RAID set is configured as RAID-1 with a spare drive, then the spare drive will be found once the degraded mode is entered. Then the auto-rebuild mode will be started. In the middle of data rebuilding, DRAM buffer is frequently needed in case certain abnormal situations happen, so a DRAM cache 112 dedicated for RAID is provided. The data in a good drive will be backed up into a spare drive in RAID-1. The DRAM cache 112 also provides a working area for data initialization, and data rebuilding in RAID-3, 5, or 6 if one of the hard disk drives fails. The RAID DRAM cache 112 usually has minimum size of 128 M bytes.

As a characteristic of the flash memory, it has much slower speed in write cycles than in read cycle. Therefore, a conventional SSD or a flash memory card also has such characteristic. To speed up the write operation, as shown in FIG. 1B, one conventional arrangement is to provide an external DRAM cache 131 for each SSD card. The DRAM cache is used as a temporary data buffer to speed up the data transfer in write operation to its corresponding SSD card. The SSD controller 121 controls N flash channels, and it also controls the DRAM cache 131.

In FIGS. 1A and 1B, the function of the RAID DRAM cache 112 is totally different from that of the SSD DRAM cache 131. The DRAM cache 131 is used by the SSD controller 121 to save the flash management tables such as bad block management, wear leveling, and FAT (file allocation table). The DRAM usually has minimum 16 M Bytes in the conventional SSD controller.

The conventional RAID storage system has the drawback that the DRAM caches increase cost and occupy spaces, in particular when there are multiple SSDs each associated with a DRAM cache. These DRAM caches are not efficiently used in most of the time; for example, the DRAM cache 112 is normally idle because data rebuilding only occurs when one of the drive fails. However if such DRAM cache 112 does not exist, the RAID data rebuilding operation would be slow in case such rebuilding operation is required.

### SUMMARY OF THE INVENTION

In view of the foregoing, an objective of the present invention is to provide a flash memory storage system with a more cost-effective and efficient arrangement of the DRAM cache memory. A plurality of flash memory modules are connected to RAID controller. The DRAM functions are shared for both RAID controller and flash modules. The DRAM can be used to store wear-leveling tables and FAT. The DRAM can be used for data pool for DMA transfer and data rebuild. The double buffering with read/write toggling technology is implemented for the DRAM cache.

An other objective of the present invention is to provide a flash memory storage system in which a flash controller is in dynamic cooperation with a RAID engine, so that the memory access and RAID operations are more efficient in the system, in a more cost-effective structure.

In one aspect of the present invention, a flash memory storage system is proposed, which comprises: a RAID controller; a plurality of flash memory module electrically connected to the RAID controller; and a DRAM cache memory shared by the RAID controller and the plurality of flash memory modules.

Preferably, a FIFO (First-In First Out register) is provided to speed up the data transfer between flash modules and RAID controller in such a flash memory storage system.

In another aspect of the present invention, a flash memory storage system is proposed which comprises: a RAID engine; a flash controller; a plurality of flash memory devices electrically connected to the flash controller; and a DRAM cache memory shared by the RAID engine and the flash controller.

Preferably, the present invention provides a plurality of channel write cache and the state machine for the channel write cache is capable of checking address boundaries. Particularly, it is capable of detecting the addresses of flash memory block boundaries.

Preferably, the present invention provides a DMA engine for use in such a flash memory storage system. The DMA (Direct Memory Access) engine implements asynchronous DMA transfer.

In the flash memory storage systems described in the above, the shared DRAM cache can be used both for data rebuild, and as a data transfer buffer of the flash memory devices.

It is to be understood that both the foregoing general description and the following detailed description are provided as examples, for illustration rather than limiting the scope of the invention.

### BRIEF DESCRIPTION OF THE DRAWINGS

These and other features, aspects, and advantages of the present invention will become better understood with regard to the following description, appended claims, and accompanying drawings.

FIG. 1A is a schematic diagram showing a conventional RAID data storage system including hard disks and a DRAM for RAID operation.

FIG. 1B is a schematic diagram showing a conventional SSD (Solid State Drive) storage system including multiple channels of NAND flash devices and a DRAM as a write cache.

FIG. 2 is a schematic diagram showing a flash memory storage system according to an embodiment of the present invention.

FIG. 3 is a schematic diagram showing a detailed structure of the RAID controller in FIG. 2.

FIG. 4 is a schematic diagram showing another embodiment of the present invention including FIFOs (First-In First-Out registers).

FIG. 5 is a schematic diagram showing a detailed structure of the RAID SSD controller according to an embodiment of the present invention.

FIG. 6A shows RAID SSD controller with channel write caches and DMA sub-engines.

FIG. 6B shows multiple channel buffers in the cache memory.

FIG. 6C shows data write operation into the cache memory under control by the RAID engine.

FIG. 6D is a schematic diagram showing the channel write cache for one channel of the flash memory storage system.

FIG. 7 is a schematic diagram showing an embodiment having a nested RAID architecture, wherein multiple DRAM caches are used.

FIG. 8 is a schematic diagram showing an embodiment having a nested RAID architecture, wherein one shared DRAM cache is used.

### DESCRIPTION OF THE PREFERRED EMBODIMENTS

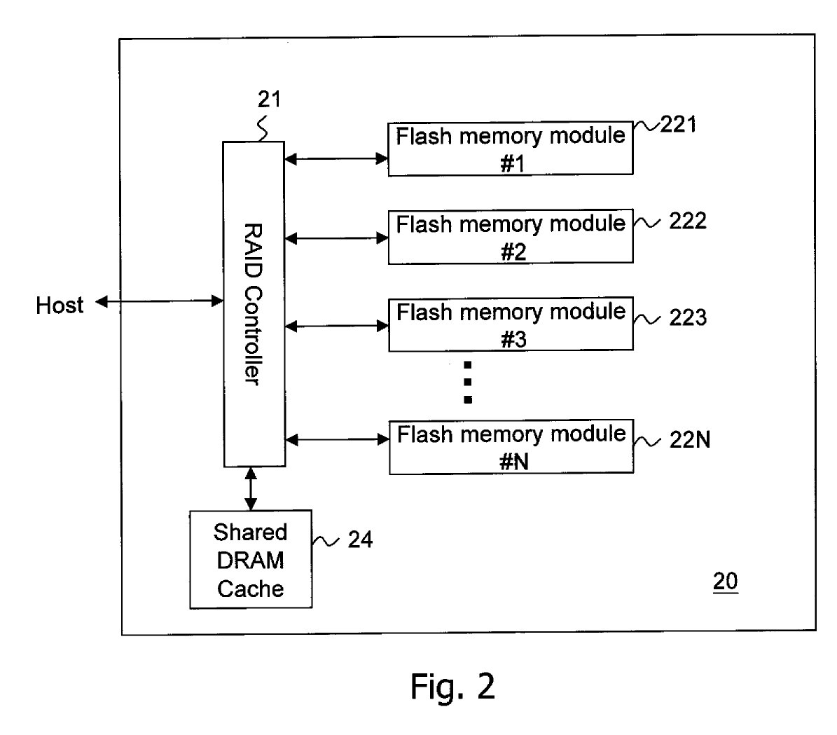

FIG. 2 is a schematic diagram showing a data storage system 20 according to a first embodiment of the present invention. The data storage system 20 includes a RAID controller 21, which controls several flash memory modules 221-22N. Each of the flash memory modules includes a flash memory controller and multiple flash memories. The flash memory modules can be in the form of SSD, EFD (Enterprise Flash Drive), or other types of flash memory cards. EFD performs ECC (Error Correction Code), wear-leveling and bad block management on the flash memories. EFD exhibits high reliability quality. The flash memory modules for example can be USB flash drive, card bus card, SD flash card, MMC flash card, memory stick, MI card, Expresscard flash card, and other types of flash memory cards. An example of the other type of flash memory card is down-grade memory cards. The down grade memory cards use down grade flash memories inside the memory cards. The down grade flash memories have some portion of array containing defective blocks. The available valid memory densities of down grade flash memories are not the normal conventional densities. 1.5 GB, 1.75 GB, etc. are some density examples for down grade flash memories.

The RAID controller 11 communicates with a cache 24, shown to be a DRAM for example but may be other types of cache memories, and this DRAM cache 24 is shared among the RAID controller 21 and the flash memory modules 221-22N. The DRAM caches provided for the flash memory modules 221-22N may thus be omitted to reduce cost and space.

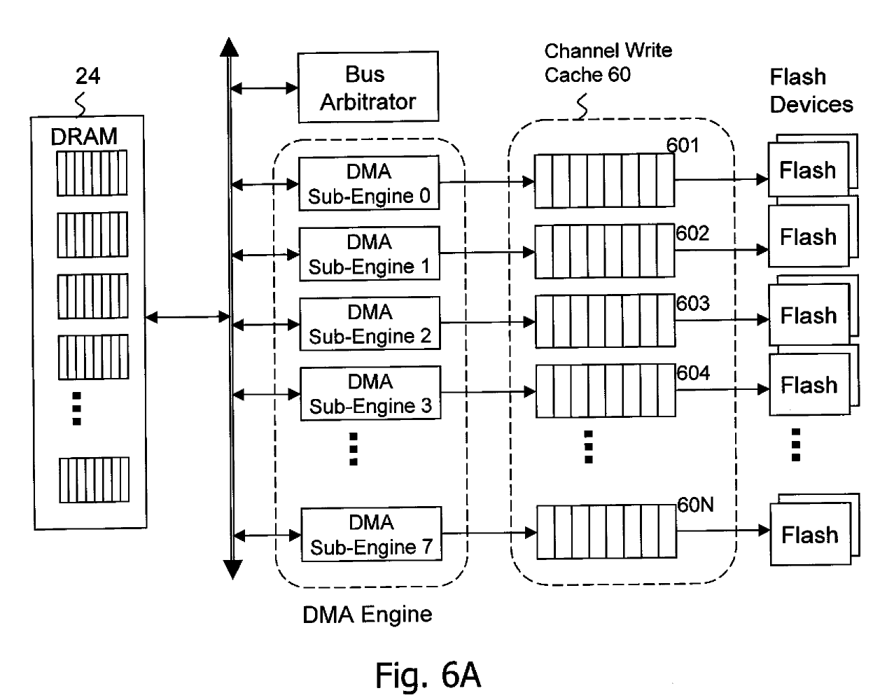

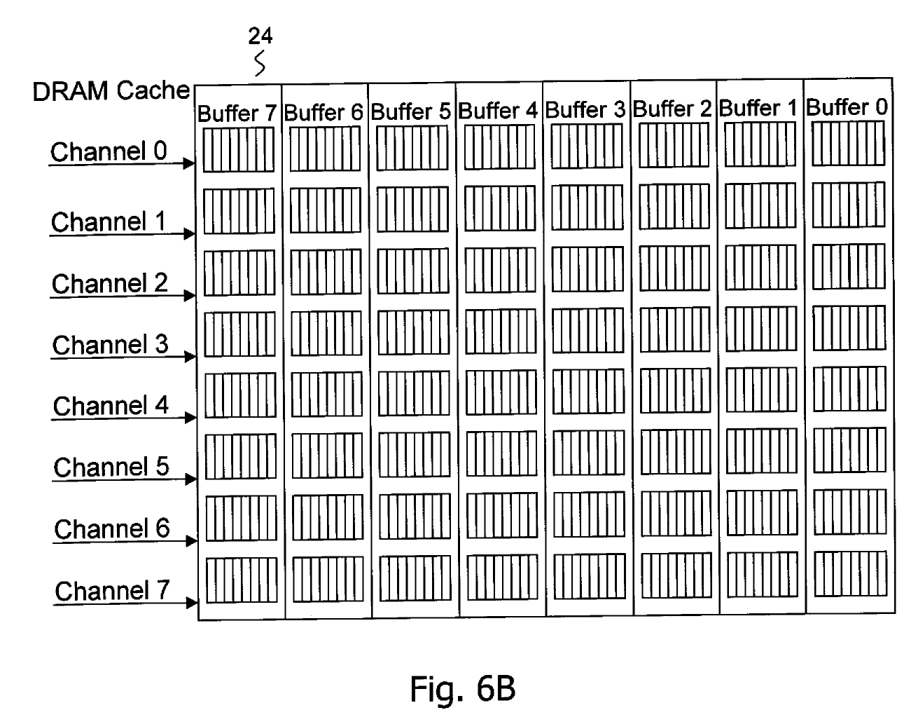

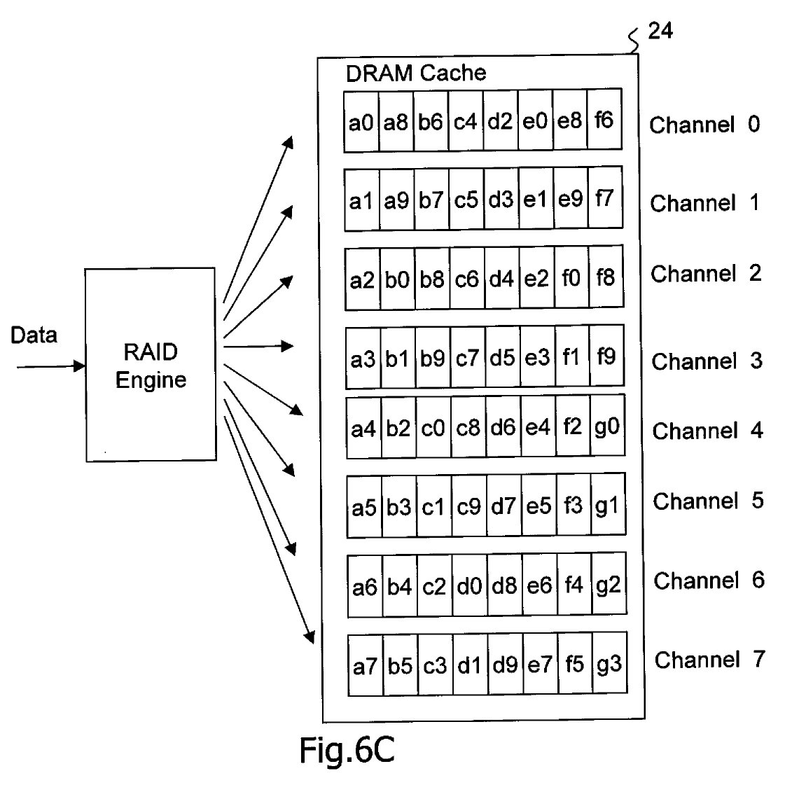

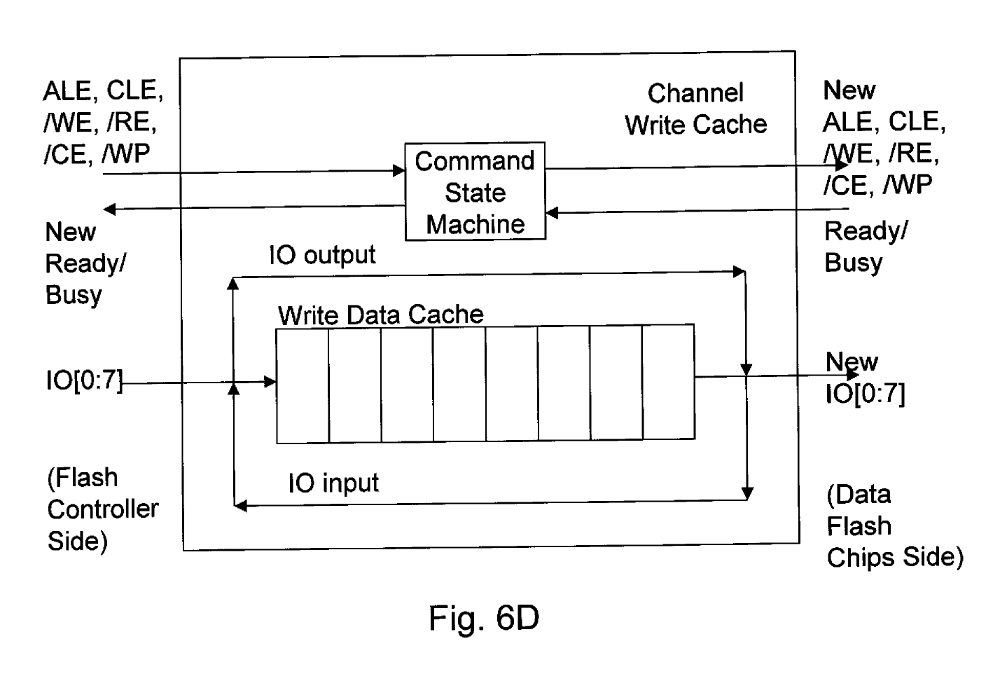

In this embodiment, the shared DRAM cache 24 performs the following functions:
(1) To store management tables including wear-leveling table, file allocation table (FAT), and uneven density table of Flash memory devices.
(2) To be used for data cache. If the data cache hit conditions are matched, the data will be read from or write to the DRAM instead of flash memories. The reduction of the write through from DRAM to flash memories will alleviate the endurance issues or wear out of the memory cells of the flash memories.
(3) To be used for temporary data pools for DMA transfer.
(4) To be used for data buffer for RAID controller to perform data rebuild while the RAID controller is configured as RAID 1, RAID-3, RAID-5 or RAID-6 or other nested RAID such as RAID-50 plus spare flash memory card or SSD.
   In case one of the flash modules fails, the RAID controller will enter into degraded mode. If the RAID set is configured as RAID-1 with a spare flash module, then the spare flash module will be found once the degraded mode is entered. Then the rebuild mode will be started. In the middle of data rebuilding, DRAM is used as data rebuild area for RAID controller and flash modules. The data in a good drive will be backed up into a spare flash module in RAID-1.
(5) To be used in error handling of channel write cache. This function will be further explained with reference to FIG. 6D.

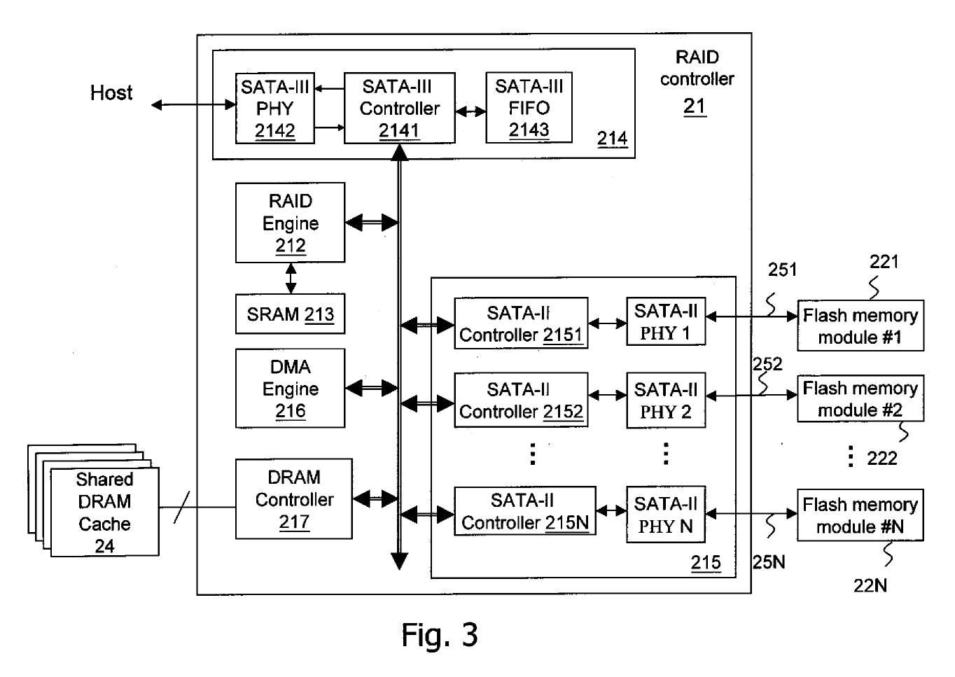

FIG. 3 shows the circuit structure of the RAID controller 21 according to one embodiment of the present invention. As shown in the figure, the RAID controller 21 includes a RAID engine 212 processing the required RAID operations according to the RAID level configuration. Preferably, the RAID engine 212 is provided with an internal SRAM cache 213 for better performance. The RAID controller 21 has an I/O interface 214 for communication with host. As an example, the I/O interface 214 is a SATA-III interface communicating with external circuits under SATA-III protocol. However, it certainly can be an interface operating under other types of communication protocols, such as USB 3.0, USB 2.0, SATA-I, SATA-IT, Ethernet Gb, PCIe 2.0, IDE, etc. The I/O interface 214 for example includes an interface controller 2141, controlling the communication through the interface 2142; and a first-in-first-out register 2143 for temporary data storage. The I/O interface 214 is not limited to what is shown in the figure, and can be modified by those skilled in this art in various ways. The RAID controller 21 also includes a memory module communication interface 215 to communicate with a plurality of flash memory modules 221-22N through a plurality of link 251-25N. In one embodiment, the memory module communication interface 215 includes several flash memory controllers 2151-215N, controlling the communication with the SSD or flash memory cards 221-22N through respective interfaces PHY1-PHYN. The RAID controller 21 may communicate with the SSD or flash memory cards 221-22N according to many possible protocols, such as SATA-II (as shown for example), or SATA-III, USB 3.0, USB 2.0, PCIe 2.0, PCIe 1.0, SD card I/F, micro SD I/F, CFast card I/F, etc.

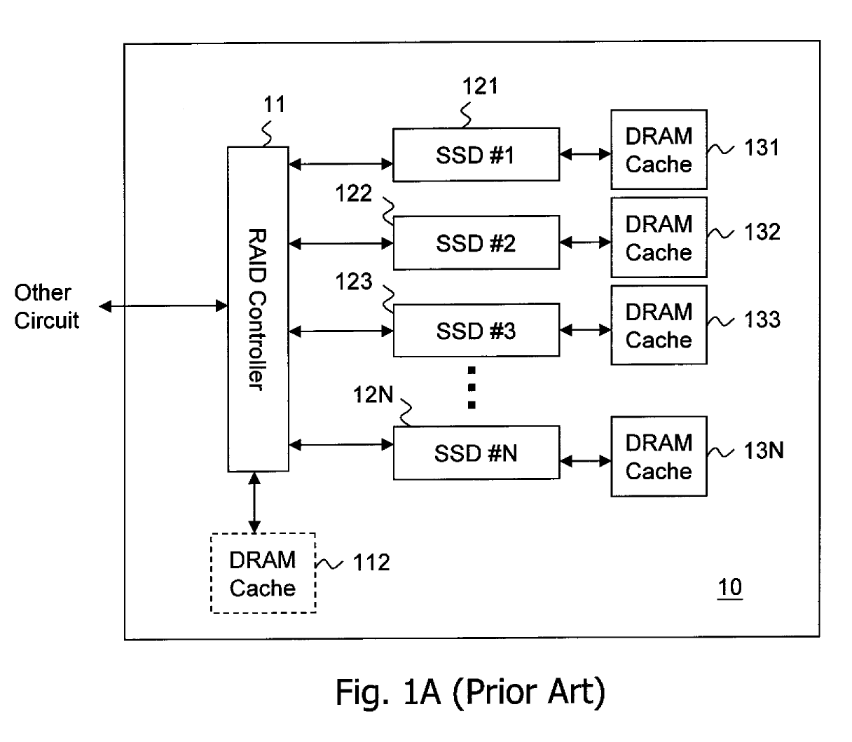

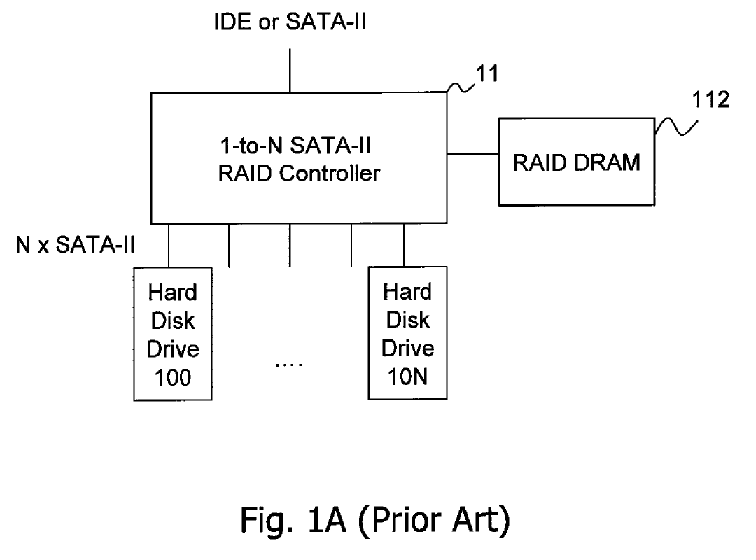

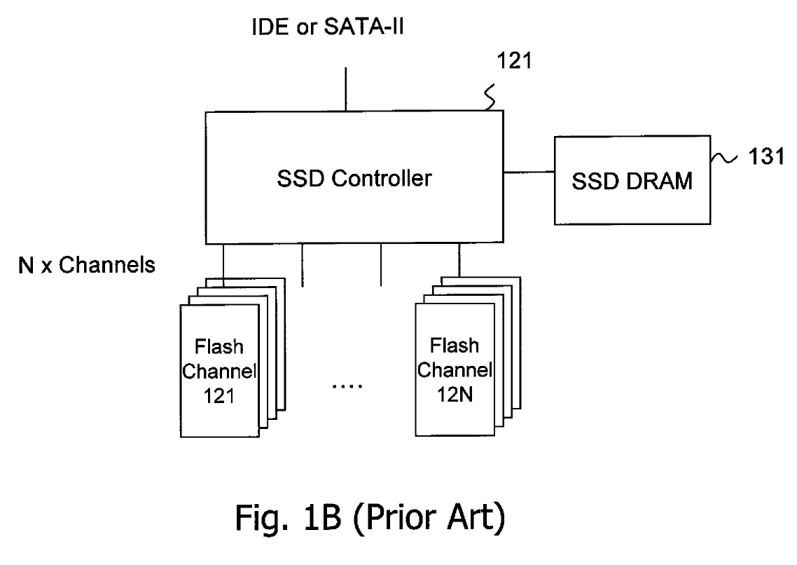

In one aspect, the RAID controller 21 is characterized in that it further includes a DMA (Direct Memory Access) engine 216, and a memory controller 217, which is a DRAM controller in this embodiment because the shared cache 24 is a DRAM. The memory controller 217 should be a corresponding type of memory controller if the shared cache 24 is another type of memory. In the prior art shown in FIG. 1, if the DRAM cache 112 is provided, it can simply be connected with the RAID engine 212 because it is a dedicated RAID cache; the DMA engine 216 and the memory controller 217 are not required. However, different from the prior art, the RAID controller 21 of the present invention needs to transfer data between the flash memory modules 221-22N and the shared DRAM cache 24. The memory controller 217 controls the shared DRAM cache 24, and the DMA engine 216 helps to speed up data access to the shared DRAM cache 24.

In the data storage system 20, there are two data transfer modes with respect to the shared DRAM cache 24: DMA mode and RAID rebuild mode. In DMA mode, in write operation, data is transferred from the host to the DRAM cache 24 via the I/O interface 214 (referred to as the front-end bus route herein after), and moved by the DMA engine 216 to the flash memory modules 221-22N via the memory module communication interface 215 and via link 251-25N (referred to as the back-end bus route herein after). In read operation, data is transferred from the flash memory modules 221-22N to the DRAM cache 24, and moved by the DMA engine 216 to the I/O interface 214 to be transferred out.

In RAID rebuild mode, data is transferred from the flash memory modules 221-22N to the DRAM cache 24, and re-distributed or re-constructed by the RAID engine 212. Thereafter, the data is transferred back to the flash memory modules 221-22N.

To share the cache memory 24 by the flash memory modules 221-22N and RAID engine 212 in the above-described architecture, the cache memory 24 must have a size large enough to avoid a bandwidth bottleneck in data transfer. The required size of the cache memory 24 depends on factors such as the RAID engine efficiency, DMA engine efficiency, front-end bus bandwidth and back-end bus bandwidth, and the number of drives or cards as well. In short, the minimum size of the cache memory 24 should be thus that the following condition is met in write operation of DMA mode:

Front bus bandwidth (BW)≧DRAM BW≧DMA BW.≧Desired drive ports BW Eq.(1)

wherein “drive ports BW” means the bandwidth of all desired SSDs or memory cards.

And the following condition is met in data-rebuild mode:

DRAM BW≧RAID Rebuild BW≧Desired drive ports BW Eq. (2)

wherein:
The Bandwidth of drive ports is the multiplication of what each drive port can support in read or write cycles;
DRAM Size=DRAM BW×depth=data-width×frequency×depth; [wherein depth is defined as DRAM Size/(data-width×frequency)]
DMA BW=Internal data bus BW×efficiency of DMA engine; Efficiency of DMA engine=(each DMA transfer time)/(processor interrupt time+processor program time+DMA transfer time+idle time between two DMA cycles);
RAID Rebuild BW=Efficiency of processor×Efficiency of RAID engine×Internal data bus BW;
Efficiency of processor=(each data transfer time)/(CPU Bandwidth).

The so called “double buffer technique” can effectively increase the depth of DRAM by the factor of 1.5 to 2.0, so the DRAM size can be reduced in the above calculation if this technique is applied.

Double buffering technique can be implemented for the DRAM cache. The DRAM cache can be divided into a read buffer and a write buffer. The write buffer can be written by RAID engine while the data is transferred from the host to the DRAM cache. The read buffer can be read by DMA engine in parallel while transfer data from DRAM cache to channel write cache FIFO and flash memory. Now the speed of transferring data from DRAM to flash memory is always slower than the speed of transferring data from the host to the DRAM cache. After the read buffer is done, it becomes a write buffer ready for next transfer. And the write buffer toggles to a read buffer.

In current state of the art, the size of the DRAM cache should preferably be larger than 1 M Bytes for one channel. The size of the DRAM cache should preferably be larger than 8 M Bytes if there are eight channels in the storage system.

In one aspect, the RAID controller 21 is capable of performing wear-leveling function to prolong the life time of flash memories inside the flash memory modules. If the wear leveling table is not small enough to put in the local SRAM, then wear leveling table can be stored in external DRAM. In other words, The RAID controller can store the necessary wear leveling table in local SRAM if the wear leveling table size is small enough.

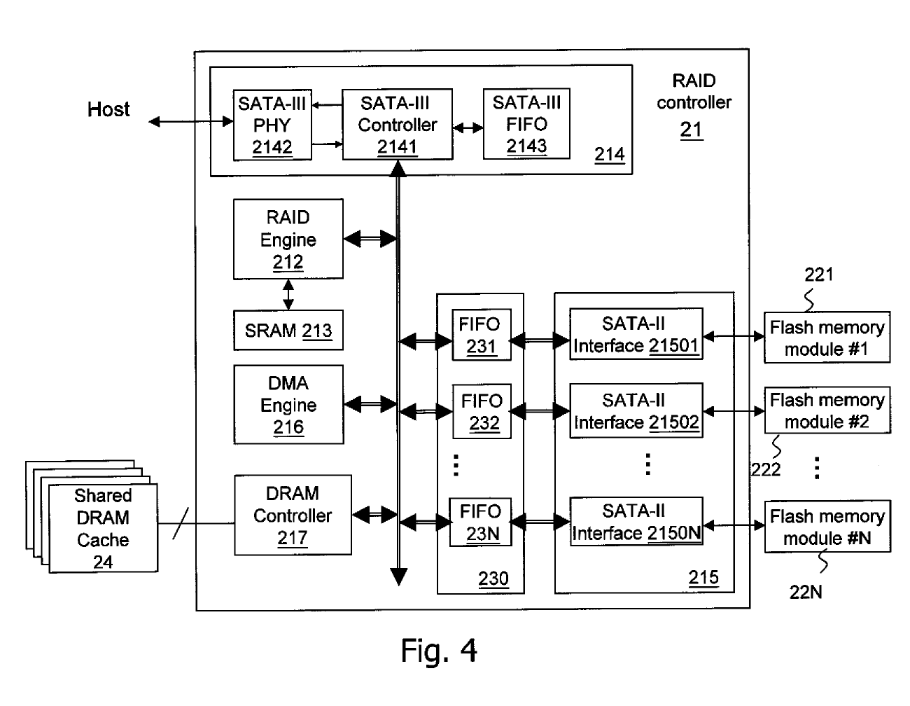

FIG. 4 shows the circuit structure of the RAID controller 21 according to another embodiment of the present invention. As shown in the figure, the RAID controller 21 includes a plurality of FIFO's 231-23N. The FIFO will improve the transfer speed between flash memory modules and the RAID controller.

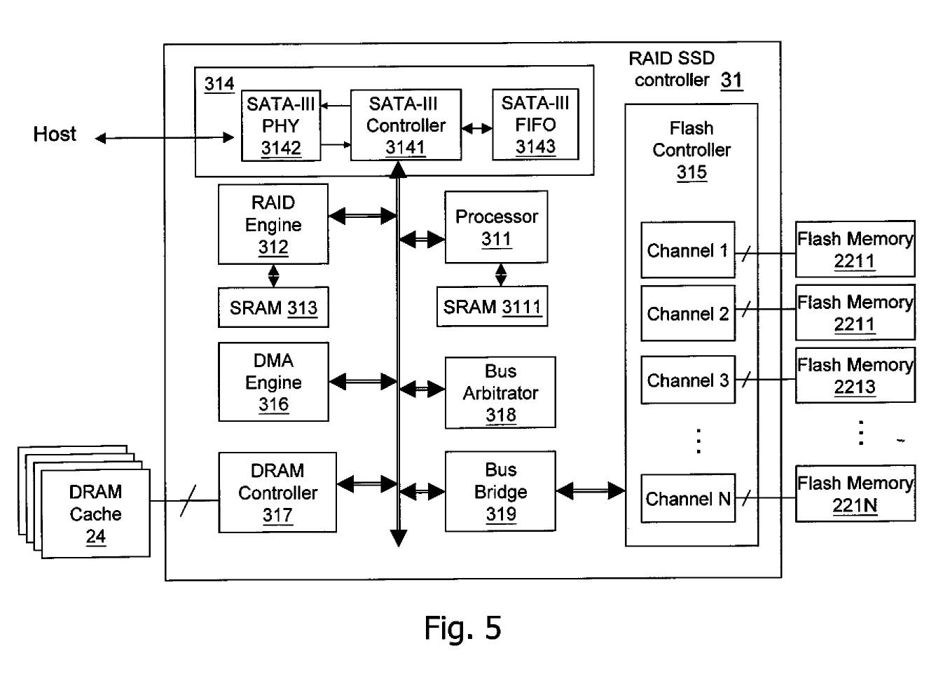

FIG. 5 shows the detailed structure of the RAID SSD controller 31 according to an embodiment of the present invention. The RAID SSD controller 31 includes a processor 311, controlling the overall operation of the RAID SSD controller 31. For better performance, preferably, processor 311 has a dedicated SRAM cache 3111. A RAID engine 312 processes RAID operations according to the RAID configuration that the data storage system 30 is configured to. Preferably, the RAID engine 312 has a dedicated SRAM cache 313. An I/O interface 314 is provided for communication with the host. The I/O interface 314, although shown as a SATA-III interface for example, can be an interface operating under communication protocols such as USB 3.0, USB 2.0, SATA-II, Ethernet Gb, PCIe 2.0, etc. The I/O interface 314 for example includes an interface controller 3141, controlling the communication through the interface 3142; and a first-in-first-out register 3143 for temporary data storage.

The RAID SSD controller 31 further includes a DMA engine 316 and a memory controller 317, to control data transfer between the DRAM cache 24 and the flash memories 2211-221N. The RAID SSD controller 31 also includes a bus arbitrator 318, and a bus bridge 319, connecting with a flash controller 315. The flash controller 315 includes multiple channels 1-N, for communication with the flash memories 2211-221N, respectively.

The RAID SSD controller 31 in this embodiment provides both the RAID control and SSD control functions.

Referring to FIGS. 6A and 6B, in one embodiment of the present invention, a channel write cache is provided in each memory channel to enhance the performance of flash memory write. By such technology, the data can be transferred from the shared DRAM cache or directly from the host to the channel write cache while simultaneously doing data write to the flash memories, to improve the speed of the write operation. When the flash memory is busy doing write operation from the buffer to the flash memory arrays, data can be transferred from the shared DRAM cache or directly from the host to the channel write cache. This technology can be applied to SLC (Single-Level Cell) and MLC flash memories as well. It can greatly improve the write operation performance especially when the MLC flash memories are used, because the write time is much slower for an MLC flash memory than for an SLC flash memory.

In one embodiment, When the Flash memory chip is busy doing data write from the buffer inside Flash memory chip to the Flash memory array, the data can be transferred from shared DRAM cache or directly from host to channel write cache.

The page buffer size for current Flash memory is from 2K Bytes to 8K Bytes. The current most popular block size of Flash memory is 128 K bytes. That is 64 pages for each block with 2 K bytes for each page. If budget is allowed, the channel write cache should be as big as 128 K bytes.

The channel write cache could be organized as a FIFO type of memory to simplify the address decoder circuits in association therewith. The channel write cache helps to alleviate the performance difference between each I/O port (e.g., SATA-II port) and each flash memory channel. It also helps to alleviate the data transfer difference between the DMA engine with DRAM cache and the flash memory device controller to maximize the write performance.

According to the present invention, in one embodiment, the DMA engine (216 in FIG. 3 or 316 in FIG. 5) is capable of performing an asynchronous DMA transfer operation, which will be explained below.

As shown in FIG. 6A, each channel buffer can be transferred into each channel write cache 601-60N by a separate DMA sub-engine, which may be a part of the DMA engine 216 or 316. In this way, data are written into flash devices asynchronously. The bus arbitrator controls the bus read access from the DRAM cache requested by each DMA sub-engine. The arbitrator also controls the write access to the DRAM cache requested by the RAID engine.

Thus, even though the MLC flash channels are written by various different program speeds, the overall serial write performance of the system through the RAID engine will not be affected by a single slower MLC flash channel.

Each channel cache can have as 64 pages as in a single block which has 1 Meg bit or 128K bytes; If there are 8 channel caches in a data buffer, the minimum DRAM cache requires 128 K bytes multiplied by 8 and equals to 1 M bytes. If there are 8 data buffers as shown in FIG. 6-c, the DRAM cache requires 8 M bytes, The minimum DRAM size is 1 M Bytes for one channel. The minimum DRAM size is 8 M Bytes for 8 channels and is 16 M Bytes if the double buffering with read/write buffers toggling technique is used for 8 channels.

Multiple channel buffers can be arranged in the shared DRAM cache as shown in FIG. 6B.

If any channel in a buffer is not finished due to slower program speed when other channels have been finished in the same data buffer, such other channels in DMA transfer can move to next data buffer without waiting for the completion of the delayed channel in the current buffer. And Even if an error is found in the data of a channel after verification, the corresponding channel cache can re-program the data within the same data buffer. Such re-programming would not significantly delay the overall data transfer speed.

In short, the asynchronous data transfer adaptively adjusts the speed of DMA transfer in each data channel within the DRAM cache if a delay or an error occurs, without delaying the overall data transfer speed, because the data does not have to be re-transferred from the host system.

When a write or erase operation to flash memory devices fails, the corresponding channel can be re-written or re-erased while the other channels remain unaffected.

When such independent channel re-write or re-erase technology is applied, it is essential for the controller to be able to handle errors and repair the problem channel, so the other channels can proceed with separate operations. To this end, the controller should be able to update the bad block management table for each channel.

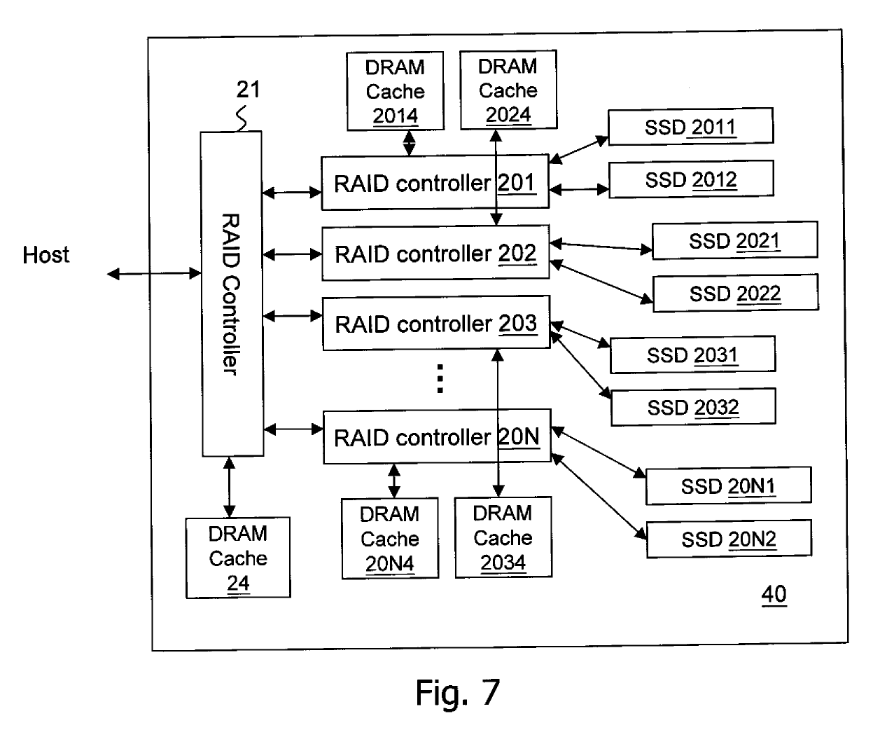

FIG. 6C explains data write operation into the cache memory 24 (or 2014-20N4 in FIG. 7) under control by the RAID engine (212 in FIG. 3 or 312 in FIG. 5). There are eight channels in the DRAM cache as shown in FIG. 6-b.

Referring to FIG. 6C, besides RAID operations on the SSD or flash memory cards, the RAID engine also performs RAID operation on data to be stored in the DRAM cache. Each data unit with 8 bytes (i.e. a0 contains 8 bytes) is distributed into channel 0 through channel 8 and written into the DRAM cache. For example, File A is distributed to each channel, a0 and a8 to channel 0, a1 and a9 to channel 1, a2 to channel 2, a3 to channel 3, a4 to channel 4, a5 to channel 5, a6 to channel 6 and a7 to channel 7. The data are prepared in this way for further transfer to the flash memory devices.

FIG. 6D shows another embodiment according to the present invention. In this embodiment, channel cache for one channel is shown (the channel for example may be the channel 1 in FIG. 5). The preferred way of operating the channel write cache FIFO is as below:
While the data is written into FIFO, the new Busy# from the state machine of the channel write cache can be issued right away before the completion of page program cycle in the flash memory.
However, at this stage, fake status checks are issued from the state machine. The real status checks will be obtained after the completion of multiple page program cycles in flash arrays.
If any page write status is bad during multiple page write operation, the whole block will be considered bad block and a new block is allocated.
All pages written into the FIFO channel write cache need to be within the same block so that the error pages can be corrected in the process of error handling.
The state machine will do a address boundary check to see if the data is written into the same block.

FIG. 7 shows another embodiment of the data storage system 40 according to the present invention, in which a nested RAID architecture is used. The nested RAID architecture includes a primary RAID controller 21 and several secondary RAID controllers 201-20N. This nested RAID architecture may be a RAID-50 or RAID-60 architecture, in this case the RAID controller 21 performs RAID-5 or RAID-6 operation and the RAID controllers 201-20N performs RAID-0 operation, or may be other types of nested RAID architecture.

In the data storage system 40, each secondary RAID controller 201-20N, controls two SSD 2011, 2012, 2021, 2022, 2031, 2032 . . . , 20N1, and 20N2. Each secondary RAID controller 201-20Nis provided with a corresponding DRAM cache 2014-20N4, shared between the two SSD controlled by the same secondary RAID controller 201-20N. Preferably, the primary RAID controller 21 is also provided with a DRAM cache 24, which may be a dedicated RAID cache, or a DMA/data-rebuild dual mode memory shared among all SSD and RAID controllers 21 and 201-20N. Each of the secondary RAID controllers 201-20N can be of the structure as shown in FIG. 3, and the primary RAID controller 21 can also be of the structure as shown in FIG. 3, except that the memory card communication interface 215 is now communicating with the secondary RAID controllers 201-20N.

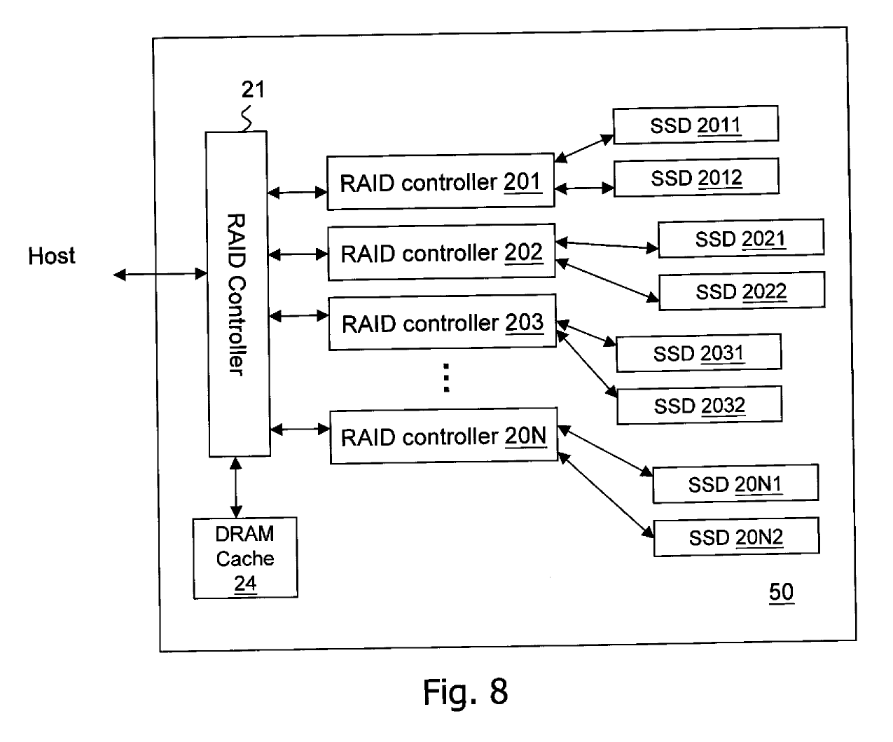

FIG. 8 shows another embodiment of the data storage system 50 according to the present invention, in which only one shared memory cache 24 is provided. This memory cache 24 is a DMA/data-rebuild dual mode memory shared among all SSD and RAID controllers 21 and 201-20N, operating both as a data read/write buffer and a RAID data rebuild buffer.

Although the present invention has been described in detail with reference to certain preferred embodiments thereof, the description is for illustrative purpose, and not for limiting the scope of the invention. One skilled in this art can readily think of many modifications and variations in light of the teaching by the present invention. For example, in FIGS. 2-6 and 7, the present invention is described with reference to SSD and SSD controller. However, it can be readily understood that the present invention can be applied to data storage system constructed by other types of flash memory cards than SSD, or by storage media other than flash memory cards. In view of the foregoing, it is intended that the present invention cover all such modifications and variations, which should interpreted to fall within the scope of the following claims and their equivalents.

What is claimed is:

1. A flash memory storage system comprising:
a RAID controller;
a plurality of flash memory module electrically connected to the RAID controller; and
a DRAM cache memory shared by the RAID controller and the plurality of flash memory modules.

2. The flash memory storage system of claim 1, wherein the DRAM cache stores FAT and wear-leveling table.

3. The flash memory storage system of claim 1, wherein the DRAM cache is used for data rebuild.

4. The flash memory storage system of claim 1, wherein the RAID controller includes a corresponding plurality of FIFOs.

5. The flash memory storage system of claim 1, wherein the RAID controller includes a DMA engine, and wherein the DRAM cache is used for data pool for DMA transfer under control by the DMA engine.

6. The flash memory storage system of claim 1, wherein the DRAM cache implements double buffering technique with read/write buffers toggling.

7. The flash memory storage system of claim 1, wherein one of the flash memory modules employ down grade flash memory.

8. The flash memory storage system of claim 1, wherein the flash memory modules are one selected from the group consisting of: solid state drive (SSD), USB flash drive, card bus card, SD flash card, MMC flash card, memory stick, MI card, and Expresscard flash card.

9. The flash memory storage system of claim 1, wherein the memory module communication interface communicates with the flash memory module according to SATA-II, SATA-III, USB 3.0, USB 2.0, PCIe 2.0, PCIe 1.0, SD card T/F, micro SD I/F, or CFast card I/F protocol.

10. The flash memory storage system of claim 1, wherein the RAID controller includes a local SRAM for storing wear-leveling table.

11. A flash memory storage system comprising:
a RAID engine;
a flash controller;
a plurality of flash memory devices electrically connected to the flash controller; and
a DRAM cache memory shared by the RAID engine and the flash controller.

12. The flash memory storage system of claim 11, wherein the DRAM cache stores FAT and wear-leveling table.

13. The flash memory storage system of claim 11, wherein the DRAM cache is used for data rebuild.

14. The flash memory storage system of claim 11, wherein the flash controller includes a plurality of channels, and each channel includes a channel write cache.

15. The flash memory storage system of claim 11, further comprising a DMA engine, wherein the DMA engine performs asynchronous direct memory transfer.

16. The flash memory storage system of claim 15, wherein the channel write cache performs address boundary check.

17. The flash memory storage system of claim 15, wherein the DMA engine does independent channel rewrite or independent re-erase operation.

18. The flash memory storage system of claim 11, wherein one of the flash memory devices employ down grade flash memory.

19. The flash memory storage system of claim 11, wherein the DRAM has a size larger than 1 M Bytes for each channel.

20. The flash memory storage system of claim 11, further comprising a local SRAM electrically connected with the RAID engine for storing wear-leveling table.
